(19) United States
(12) Patent Application Publication
(10) Pub. No.: US 2023/0144928 A1
(43) Pub. Date: May 11, 2023

(54) METHOD FOR PROVIDING A CLIENT COMPUTER DEVICE WITH ACCESS TO A DATABASE MANAGEMENT SYSTEM

(71) Applicant: Nicolas De Pomereu d' Aligre, Paris (FR)

(72) Inventor: Nicolas De Pomereu d' Aligre, Paris (FR)

(21) Appl. No.: 18/091,493

(22) Filed: Dec. 30, 2022

Related U.S. Application Data
(63) Continuation-in-part of application No. 16/479,316, filed on Jul. 19, 2019, now abandoned.

(30) Foreign Application Priority Data
Jan. 25, 2017 (FR) 17/50591

(51) Int. Cl. G06F 21/54; G06F 21/51

(52) U.S. Cl. CPC G06F 21/54; G06F 21/51

(57) ABSTRACT

A method for providing a client computer device with access to a database management system via an http connection with an agent server, comprising a step of generating a query by said client device; a step of processing said query by said agent server to search said database, according to the parameters contained in said query, wherein said query is an SQL query; said agent server has a security module parametrizable by dependency injection, to analyze the content of said query and the parameters thereof; and conditionally ensure the transmission of said query to an extraction module; said extraction module converting the query into JDBC instructions transmitted to said database management system; said extraction module receiving in response the data in JDBC format and converting it into a JSON stream; and the agent server transmits said JSON stream to the client device.

This application is a Continuation-in-Part of U.S. application Ser. No. 16/479,316 filed Jul. 19, 2019.

### BACKGROUND

The present invention relates to the field of access by a client computer device to a relational database management system (RDBMS) that can be operated by a data manipulation language and SQL instructions.

A database management system is composed of several computer programs: an engine, a catalogue, a query processor, a command language, SQL for the present invention and tools.

The database engine manipulates database files, transmits data to and from other programs, and verifies data consistency and integrity.

The catalogue contains a description of the database organization, access control lists, the names of persons authorized to manipulate the database and a description of the consistency rules.

The query processor performs the requested operations.

The query language makes it possible to manipulate the content of the database. SQL has become the standard language.

DBMS tools are used to create reports, screens for entering information, import and export data to and from the database, and manipulate the catalogue. These tools are used by the database administrator to perform backups, restore data, authorize or deny access to certain information, and make changes to the content of the database—creation, reading, modification and deletion of information, abbreviated CRUD (create, read, update, delete). These tools are also used to monitor engine activity and perform tuning 26 operations.

In a relational DBMS, requests made to the DBMS are typically processed in five steps:
Client software communicates with the DBMS using its programming interface via a network. A DBMS communication device verifies the client's identity, then transmits the client's requests to the DBMS core and transmits to the client the information extracted by the DBMS;
the DBMS then creates a thread to process the query. A program controls all threads and decides which ones are executed immediately and which ones will be executed later, depending on the computer's workload;
when executing the thread, a compiler transforms the text expressed in the DBMS query language into an execution plan, the form of which imitates that of an algebraic expression using relational algebra, then a set of “operator” programs calculate the result of the expression by performing operations such as join, Cartesian product, sorting and selection;
operators use the database engine, which executes algorithms (called access methods) to retrieve information and maintain the structures of the database files.

Once the information is obtained by the file manipulation program, it is sent to the execution thread and then to the communication device that transmits it to the client.

The DBMS is generally run on a computer server communicating with client devices via a computer network, mainly the Internet. These client devices, once mainly computers, are now very diverse: cellular phones (smartphones), tablets, but also communicating objects that sometimes do not have a human-machine interface, to automatically exchange information between local sensors and a remote database.

More specifically, the invention relates to the technical problem of communication between the client device and the server running the computer code of the relational database management system, and securing access to this server to avoid malicious queries or queries from an unauthorized device that could inappropriately modify or even destroy the data stored in the database.

The communication between the two devices is generally performed with an http client-server communication protocol using a TCP transport layer.

### STATE OF THE ART

The U.S. Pat. No. 6,882,996 describing a method for querying a parameterized database system is known in the state of the art.

The method described in this prior art document is intended to enable a client to access a database system on a server via an Internet connection from middleware in communication with the client and the server.

The query language of the database system is SQL. The data that satisfy the query is sent via HTTP protocol in Extensible Markup Language (XML).

Access to the file is controlled in response to a client query for data containing specific values and methods, it being specified that this query is not an SQL query in order to avoid inappropriate access.

The middleware includes a router that receives the client's query. It includes a servlet that replaces some parameters in the parametrized instruction with corresponding values from the client query to establish an SQL statement. The servlet sends the SQL statement to the database system for execution.

The European patent publication EP1860577 describing a method and system for transferring data contained in an electronic message, in particular a MIME attachment (multipurpose Internet mail extensions), to a relational database containing the steps of:
providing an XML sequence that determines how the data should be processed,
executing a sequencer, which takes the message and the XML sequence as an input, where the execution of the sequence involves the execution of at least one SQL statement to access the relational database.

The U.S. Pat. No. 6,105,043 describes another example of a method for creating macro language files to execute SQL queries in a relational database management system via the Internet's World Wide Web. In accordance with this prior art solution, web users can ask for information from the RDBMS software via HTML input forms, the query is then used to create an SQL statement for execution by the RDBMS software. The results output by the RDBMS software are in turn transformed into HTML format for presentation to the web user.

“Code Injection,” as the combined 2 words can cover three completely different fields/arrays. First “SQL Code Injection.” This is a way of attacking programs by injecting modified source code of SQL statements. Note that “SQL Code Injection” is now a standard and unequivocal terminology used by all security experts. Second, “Code injection” via Dependency injection (DI), as disclosed below. “Code” means only binary code to be executed by the main software. Third, “Source code injection & loading.” This is described in Adams [US 2009/0031291 A1] in the purpose of translating source code of a language (VB) into the source code of another language (Java).

The three definitions are clearly different in meaning. The source code of a VB program is “injected” into a software as designed by Adams. The Adams software is able to parse for lexical and syntactic analysis the injected source code. A Translate Controller of the software, helped by a Translation Interface Library (aka a list of translation rules), then translates the injected VB source files into newly created Java source files. The runtime behavior of the VB code and the Java code that will be equivalent when compiled and executed.

### DRAWBACKS OF THE PRIOR ART

The prior art solutions focus on the security of exchanges between the client and the DBMS by using an instruction format that expressly excludes SQL instructions. This implies the use of a dedicated application on the client device, with disadvantages regarding the robustness of the exchanges, the processing time and the IT resources implemented on the client device.

Adams concerns only actions on inputted source code in order to produce another set of source code. No binary code is injected in the Adams running software in order to modify its behavior and execution paths at run time. The Adams software execution is not depending on external binary code, and will always be the same when inputting the same VB source code. There is no Dependency Injection, binary code loading/injection, or dynamic class loading in Adams.

### SUMMARY

In order to remedy these disadvantages, the invention, in its broadest sense, relates to a method for providing a client computer device with access to a database management system via an http connection with an agent server, comprising:
a step of generating a query by said client device
a step of processing said query by said agent server to search said database, according to the parameters contained in said query, characterized in that:
   said query is an SQL query
   said agent server has a security module parametrizable by dependency injection coupled with dynamic class loading, allowing loading of [java] code that is not known about before the said agent server starts,
to analyze the content of said query and the parameters thereof and
conditionally ensure the transmission of said query to an extraction module
   said extraction module converting the query into JDBC instructions transmitted to said database management system
   said extraction module receiving in response the data in JDBC format and converting it into a JSON stream
   the agent server transmits said JSON stream to the client device.

Fundamentally, dependency injection consists of passing parameters to a method. In software engineering, dependency injection is a design pattern in which an object or function receives other objects or functions that it depends on. A form of inversion of control, dependency injection aims to separate the concerns of constructing objects and using them, leading to loosely coupled programs. The pattern ensures that an object or function which wants to use a given service should not have to know how to construct those services. Instead, the receiving ‘client’ (object or function) is provided with its dependencies by external code (an ‘injector’), which it is not aware of. Dependency injection helps by making implicit dependencies explicit and Dependency injection allows dynamic [Java] class loading, thus allowing to define the name of the dependency class in a .ini or .properties file and load the class at agent server startup, without the agent server knowing preventively the name of the [Java] class, as in following samples:

#Name of class is defined in an external “.properties” text
file
sqlFirewallManagerClassNames=DenyExceptOnWhitelistManager
// Class “DenyExceptOnWhitelistManager” whose unknown
// to server agent, is loaded at startup after
// extraction from the just above “.properties” text file:
Class<?> c = Class.forName(sqlFirewallClassName);
Constructor<?> constructor = c.getConstructor( );
SqlFirewallManager sqlFirewallManager
= (SqlFirewallManager) constructor.newInstance( );
.

Advantageously, said parametrizable security module includes means for limiting the number of transmitted lines.

According to a particular alternative solution, said parametrizable safety module includes means for triggering an action according to said analyzed query, said action particularly consisting in
sending a message of revocation of a user
the sending of an alert message.

Preferably, said parametrizable security module includes a default configuration file.

### BRIEF DESCRIPTION OF THE DRAWINGS

The characteristics and advantages of the invention will appear upon reading the following description, given only by way of a non-restrictive example while referring to the appended drawings, wherein:

FIG. 1 is a block diagram of a system according to an exemplary embodiment of the invention,

FIG. 2 is a block diagram of the agent server.

### DETAILED DESCRIPTION

### Hardware Architecture

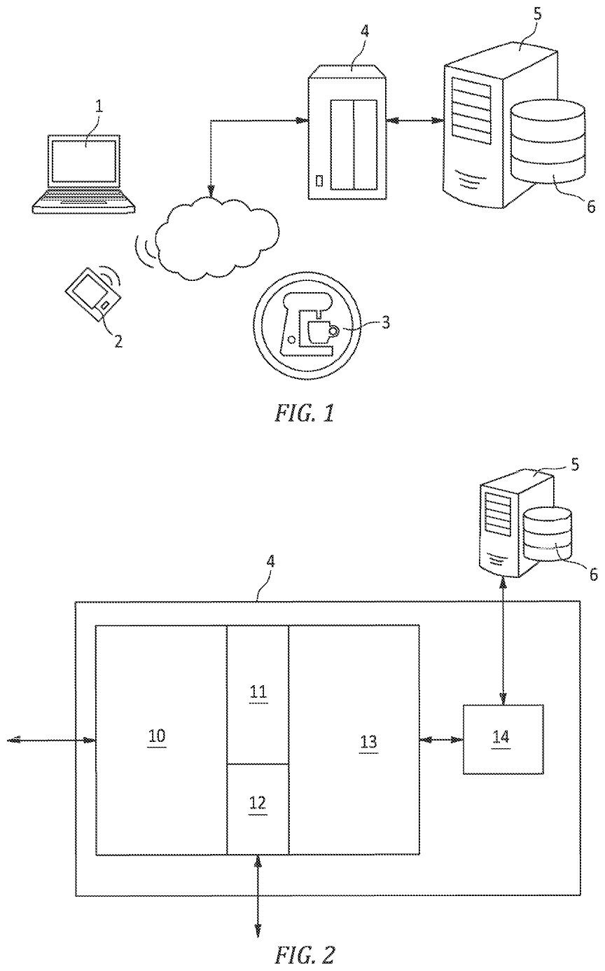

FIG. 1 shows a block diagram of a system according to the invention.

The client devices 1 to 3 can be a computer 1, a cellular phone (“smartphone”) or a tablet 2 or a connected object 3. The client devices 1 to 3 have a communication interface including a physical layer, a data link layer, an IP network layer, a TCP transport layer and an http session layer.

They are connected via the Internet network to an agent server 4 which is in turn connected to a server 5 for processing the database system 6.

The agent server 4 has the ability to maintain a session specific to it. It can, for example, be an ICAP server, or an agent server with a status memory.

The latter also includes modules described in greater details in FIG. 2, for processing the queries from the client devices 1 to 3 and the exchanges with the server 5 for processing the database system 6.

The agent server 4 has an analysis stage 10 that extracts SQL statements from the client data as an http query, as well as the identifier of the client device that transmitted the query.

Of course, the example described is not exhaustive, the invention can be implemented with a single server, combining the functionalities of the agent server 4 and the server 5 for processing the database 6.

This data is then transmitted to a parametrizable filter stage 11 comparing the data via a program 12 which makes it possible to define authorized commands for the client device corresponding to the identifier extracted by the analysis stage 10. This program can be modified by dependency injection, to adapt the authorized or prohibited commands according to the specificities of the context of use of the database concerned.

If the query transmitted by the analysis stage 10 contains unauthorized commands, the filtering stage 11 sends the client device a notification that the query has not been processed.

If the query transmitted by the analysis stage 10 contains incorrect commands, the filtering stage 11 sends back to the client device an error notification with a code indicating the nature of the error and a message.

If the query contains only authorized commands, the filter stage 11 transmits to a JDBC pilot constituting a gateway for access to a database 6 management system 5.

The query is executed on the database 6 management system 5 and the response is then transmitted to the client device 1 to 3 corresponding to the above-mentioned identifier.

### Detailed Exemplary Embodiment

The following description presents examples of a code for a query to connect to a database according to the invention.

A query to connect to the remote database makes an http call in GET or POST from the client device.

Example with an http call in GET;

https://www.acme.com/aceql/user1/my_db/connect?pass word=MySecret_1234

The agent server understands that the connection identifier (user1, MySecret_1234) wants to connect to the SQL my_db database.

The security module checks, via the injected Java authentication code, if the couple (user1, MySecret_1234) has the authorization to connect.

This is done via the Java code of the login method (String username, char [ ]) of the instance of the DatabaseConfigurator class type injected by dynamic class loading at server agent startup into the security module.

If so, a single security token for use in the following http mailings is returned as a response in a JSON envelope:

{
status”:“OK”
“token”:“ qsd6bmhqnc8bosebc3crvipr81”
}

If not so, an http 401 UNAUTHORIZED status is returned to the customer.

It is now possible to program an SQL query from the client device, via an http call in GET or POST, by passing the authentication token again

https://www.acme.corn/aceql/user1/qsd6bmhqnc8bosebc3 crvipr81/my_db/select

with the http parameter:
name “sql”
value: the content of the SQL query is for example “select * from customer” URL encoding with
uTF-8 encoding. (A DELETE, INSERT, UPDATE instruction could also have been sent).

The http call dispatches the query to the agent server. The security module via the injected code of the instance of the DatabaseConfigurator class checks that this call is authorized, via several control methods:
verifyAuthToken

Verification that the token is valid/authentic and not expired.
AfterAfterAnalysis Allocation:

Method that makes it possible to analyze in detail the syntax of the SQL query, as well as the parameters passed.
allowStatementClass:

Method that makes it possible to authorize or not a Statement that is not a PreparedStatement

If the security checks fail, an http code 401 is returned to the customer device.

If the security checks are successful, the agent server then passes the order to the SQL database via a JDBC call. The JDBC call returns a response that is forwarded to the agent server.

The agent server then formats the SQL data in JSON and returns this JSON content to the client device:

{
status”:“OK”
query_return_lines“:[
row_l”:[
{
“col_index”:1,
“col_name”:“customer_id”, “col_value”: 1111
},
{
“col_index”:2,
“col_name”:“customer_name”,“col_value”:“Smith”
},
{
“col_index”:3,
“col_name”:“customer_age”, “col_value”: 30
}
r
row_2”:[
{
“col_index”:1,
“col_name”:“customer_id”, “col_value”:2222
},
{
“col_index”:2,
“col_name”:“customer_name”, “col_value”:“Wesson”
},
{
“col_index”:3,
“col_name”:“customer_age”, “col value”:31
}
]
}
]
}

SQL connection modification commands can also be sent. Examples:

Switching to transaction mode:

https://www.acme.com/aceql/username/qsd6bmhqnc8bose bc3crvipr81/my_db/set auto commit/false

Validation of an ongoing transaction:

https://www.acme.com/aceql/username/qsd6bmhqnc8bose bc3crvipr81/my_db/committee

Cancellation of an ongoing transaction:

https://www.acme.corn/aceql/username/qsd6bmhqnc8bose bc3crvipr81/my_db/rollback

When the client device has finished its session, it can safely send a disconnection command:

https://www.acme.com/aceql/user1/qsd6bmhqnc8bosebc3crvipr81/my_db/disconnect

### Configuration Module Interface

The following description shows the DatabaseConfigurator configuration module interface.

The configuration module provides a default configuration, allowing a quick start without the need for prior programming.

It also includes a configuration file of the JDBC link to the database(s) that could be accessed from the client device.

The following disclosure shows an example of a default configuration file, providing for the transmission of all commands, and a session duration of 24 hours.

What is claimed is:

1. A method for providing a client computer device with access to a database management system via an http connection with an agent server, comprising:
a step of generating a query by said client device
a step of processing said query by said agent server to search said database, according to the parameters contained in said query, wherein said query is an SQL query
said agent server has a security module parametrizable by dependency injection to extract the content of said SQL statements from the client data as an http query, as well as an identifier of the client device that transmitted the query, and the parameters thereof;
to transmit the parameters thereof to a parametrizable filter stage comparing the data via a program which makes it possible to define authorized commands for the client device corresponding to the identifier and parameters extracted by an analysis stage,
this program is modified by dependency injection to adapt the authorized or prohibited commands according to specificities of the context of use of the database concerned;
conditionally ensure the transmission of said query to an extraction module;
if the query transmitted by the analysis stage contains unauthorized commands, the filtering stage sends the client device a notification that the query has not been processed;
if the query transmitted by the analysis stage contains incorrect commands, the filtering stage sends back to the client device an error notification with a code indicating the nature of the error and a message,
if the query contains only authorized commands, the filter stage transmits to a JDBC pilot constituting a gateway for access to a database management system;
said extraction module converting the query into JDBC instructions transmitted to said database management system;
said extraction module receiving in response the data in JDBC format and converting it into a JSON stream; and
the agent server transmits said JSON stream to the client device.

2. The method for providing a client computer device with access to a database management system according to claim 1, wherein said parametrizable security module includes means for limiting the number of transmitted lines.

3. The method for providing a client computer device with access to a database management system according to claim 1, wherein said parametrizable security module includes means for triggering an action according to said analyzed query.

4. The method for providing a client computer device with access to a database management system according to claim 3, wherein said action comprises sending a message of revocation of a user.

5. The method for providing a client computer device with access to a database management system according to claim 3, wherein said action comprises sending an alert message.

6. The method for providing a client computer device with access to a database management system according to claim 1, wherein said parametrizable security module includes a default configuration file.
